(19) United States
(12) Patent Application Publication
(10) Pub. No.: US 2007/0035836 A1
(43) Pub. Date: Feb. 15, 2007

(54) Retroreflector, retroreflector assembly, and method of making retroreflector and retroreflector assembly

(76) Inventor: James Joseph Lyons III, Gerrardstown, WV (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/493,846

(22) Filed: Jul. 27, 2006

Related U.S. Application Data
(60) Provisional application No. 60/702,663, filed on Jul. 27, 2005.

(51) Int. Cl. G02B 5/122

(52) U.S. Cl. 359/529

(57) ABSTRACT

A hollow retroreflector includes three mutually perpendicular reflective plates each having at least one hole on a surface thereof and at least three threaded fasteners, such as screws or bolts. One of the threaded fasteners passes though the holes of each adjoining pairs of reflective plates. Beneficially, epoxy is applied to at least one surface of each adjoining pair of reflective plates before passing the threaded fastener through the holes of each adjoining pair of reflective plates. The hollow retroreflector may be incorporated into a hollow retroreflector assembly by passing at least one threaded fastener through a hole in a hollow retroreflector mount and through one of the holes in one of the reflective plates.

### CROSS-REFERENCES TO RELATED APPLICATIONS

This patent application claims priority under 35 U.S.C. § 119(e) from U.S. Provisional patent application 60/702,663 filed Jun. 27, 2005 the entirety of which is hereby incorporated by reference herein for all purposes as if fully set forth herein.

### BACKGROUND AND SUMMARY

1. Field

This invention pertains to the field of retroreflectors, more particularly the field of hollow retroreflectors, and more specifically a hollow retroreflector capable of tolerating extreme temperatures without catastrophic failure or substantial degradation in optical performance.

2. Description

Hollow retroreflectors, consisting of three plates having optically flat reflective surfaces disposed at right angles to each other, are well known in the art. In general, hollow retroreflectors return reflected light along a parallel path to incident light. In insuring this performance, the relative perpendicularity of the reflective surfaces needs to be maintained. Hollow retroreflectors are precision optical devices that are often required to maintain very precise performance tolerances over a wide variety of environmental conditions. Such devices may be sold and delivered as standalone devices, but are often sold and delivered as hollow retroreflector assemblies where a hollow retroreflector is mounted to a retroreflector mount in order to minimize the affect of external stresses that the retroreflector may be subject to in operation.

Existing hollow retroreflectors and hollow retroreflector assemblies are assembled by gluing three glass mirrors together so that each mirror is perpendicular (at 90 degrees) to the adjoining mirrors. Epoxy is the only feature which holds such a hollow retroreflector together. Such existing hollow retroreflectors and hollow retroreflector assemblies are quite sensitive to temperature variations. Adhesives generally considered acceptable for such hollow retroreflector assemblies are not suitable for high temperature use because the epoxy ingredients begin to breakdown at temperatures between 150 and 200 degrees F. When such a hollow retroreflector is subjected to temperatures of 200 degrees F. or above, the adhesive degrades and optical performance is completely lost. Often, the adhesive will loose all qualities and the mirrors will fall apart causing catastrophic failure.

Furthermore, hollow retroreflectors made of glass mirrors can break when they experience loads beyond that which the glass and glue can withstand.

Accordingly, it would be advantageous to provide an improved hollow retroreflector capable of tolerating extreme temperatures without catastrophic failure or substantial degradation in optical performance. It would also be advantageous to provide an improved hollow retroreflector assembly capable of tolerating extreme temperatures without catastrophic failure or substantial degradation in optical performance. It would further be advantageous to provide a method of making such a retroreflector and retroreflector assembly. Other and further objects and advantages will appear hereinafter.

The present invention comprises a retroreflector, retroreflector assembly, and method of making a retroreflector and retroreflector assembly.

In one aspect of the invention, a hollow retroreflector comprises three mutually perpendicular reflective plates each having at least one hole in a surface thereof; and at least three threaded fasteners, each one of the threaded fasteners passing though the holes of an adjoining pair of the three mutually perpendicular reflective plates.

In another aspect of the invention, a hollow retroreflector assembly comprises a hollow retroreflector, including three mutually perpendicular reflective plates each having at least one hole in a surface thereof, and at least three threaded fasteners, each one of the threaded fasteners passing though the holes of an adjoining pair of the three mutually perpendicular reflective plates; and a hollow retroreflector mount having a hole passing therethrough, wherein at least one of the screws or bolts passes through the hole in the mount and through the at least one hole of one of the reflective plates.

In yet another aspect of the invention, a method of making a hollow retroreflector comprises arranging three reflective plates, each having at least one hole in a surface thereof, to be mutually perpendicular to each other to form three adjoining pairs of reflective plates; and passing a threaded fastener though the holes of each adjoining pair of reflective plates.

In still another aspect of the invention, a method of making a hollow retroreflector assembly comprises arranging three reflective plates, each having at least one hole in a surface thereof, to be mutually perpendicular to each other to form three adjoining pairs of reflective plates; and passing a threaded fastener though the holes of each adjoining pair of reflective plates, wherein at least one of the threaded fasteners is also passed through a hole in a hollow retroreflector mount.

In yet a further aspect of the invention, A method of making a hollow retroreflector assembly comprises arranging three reflective plates, each having one or more holes in a surface thereof, to be mutually perpendicular to each other to form three adjoining pairs of reflective plates; passing a first threaded fastener though at least one of the holes of each adjoining pair of reflective plates; and passing a second threaded fastener through at least a second one of the holes in one of reflective plates and through a hole in a hollow retroreflector mount.

### BRIEF DESCRIPTION OF THE DRAWINGS

FIG. 1 shows a front view of a retroreflector assembly;

FIG. 2 shows a side view of the retroreflector assembly of FIG. 1;

FIG. 3 shows a single reflective plate of a hollow retroreflector that may be used in the retroreflector assembly of FIGS. 1 and 2;

FIG. 4 shows another single reflective plate of a hollow retroreflector that may be used in the retroreflector assembly of FIGS. 1 and 2.

### DETAILED DESCRIPTION

Described herein is an improved retroreflector and retroreflector assembly capable of withstanding extreme high and low temperatures, and referred to herein as an Extreme Temperature Retroreflector (ETR) and ETR assembly.

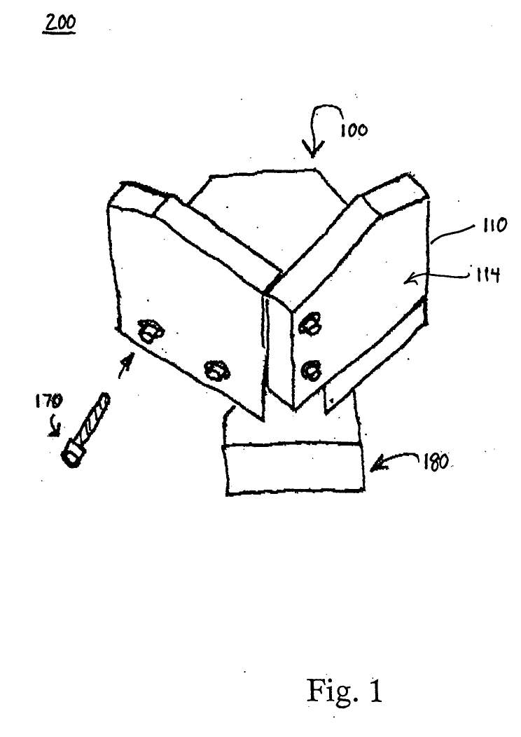

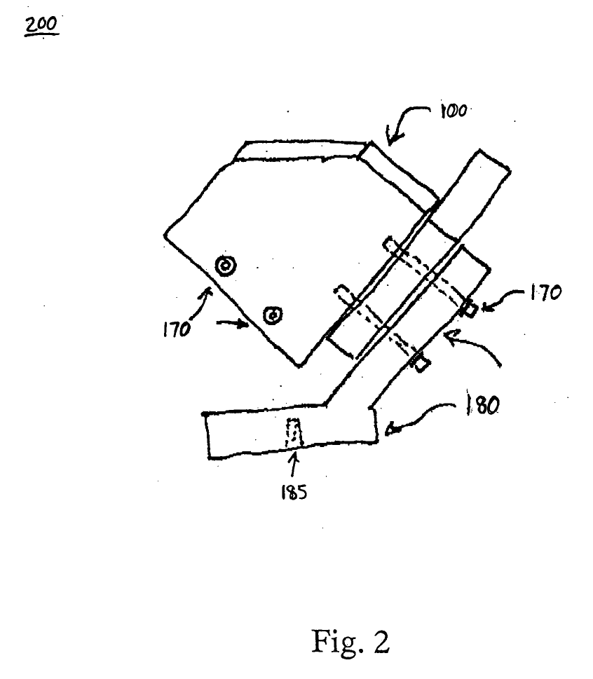

FIGS. 1 and 2 show front and side views of an ETR assembly 200. ETR assembly 200 comprises a retroreflector (ETR) 100 having three optically flat mirrors or reflective plates 110; each mirror 110 being constructed with long and short sides which are perpendicular to each other. Beneficially, each of the three mirrors or reflective plates 110 is made of metal. Preferably each mirror or reflective plate 110 comprises aluminum, but other metals such as steel, beryllium, etc. can be used.

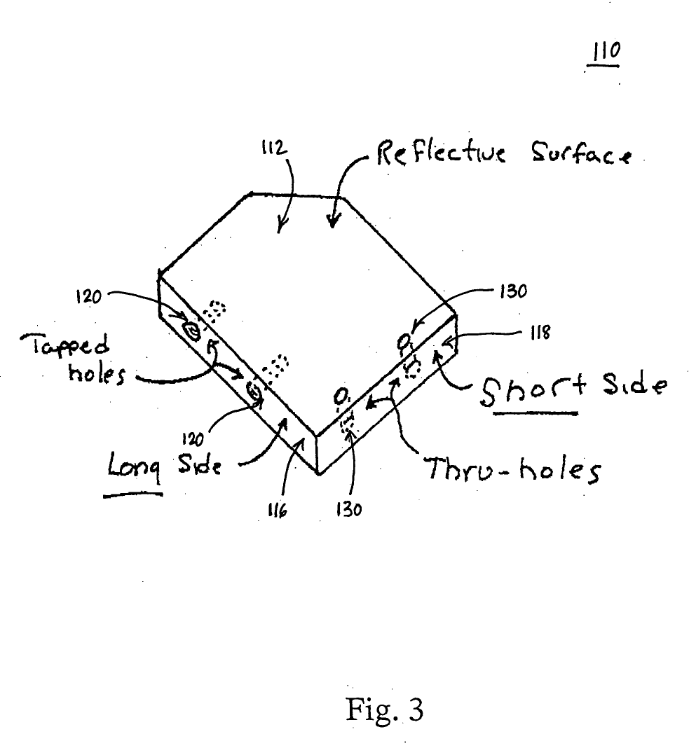

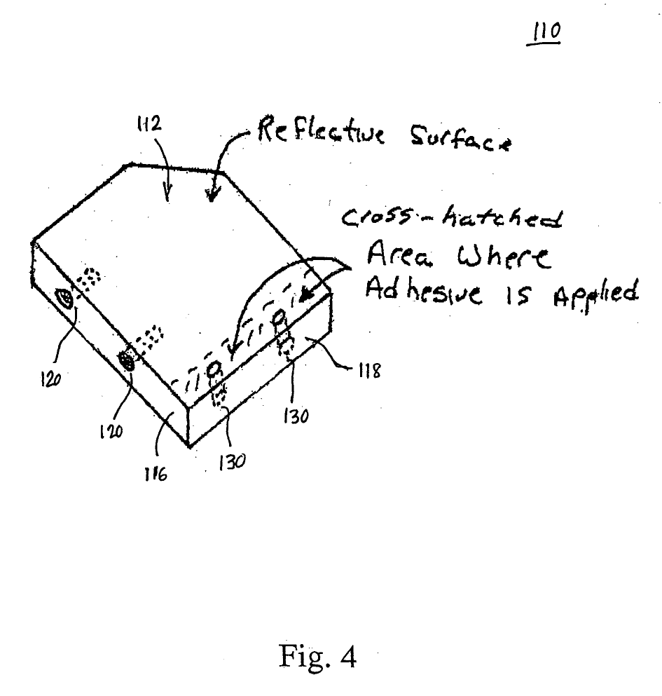

As shown in FIGS. 3 and 4, a long side 116 of each reflective plate or mirror 110 has one or more (preferably a series of) first holes 120 provided therein at specific locations parallel to, yet in between, the reflective surface 112 and surface 114 (which may be non-reflective) of the reflective plate 110. Beneficially, these first holes 120 are tapped with a thread to accept a threaded fastener, such as a screw or bolt thread. Beneficially, these first holes 120 do not pass all the way through the reflective plate or mirror, but only reach to a predetermined depth. Meanwhile, each reflective plate or mirror also has one or more (preferably a series of) “through-holes” 130 which pass completely through the reflective plate 110 at specific locations adjacent or near a short side 118, perpendicular to the reflective (mirror) surface 112. Beneficially, through-holes 130 may also be tapped with a thread to accept a threaded fastener, such as a screw or bolt thread.

The first (beneficially, tapped) holes 120 and the through-holes 130 are positioned to properly align with each other when the reflective plates or mirrors 110 are assembled in an over-lapping configuration whereby the long side 116 is positioned underneath the short side 118 of the adjoining reflective plate or mirror 110. The third reflective plate or mirror 110 is positioned in the same fashion creating an overlapping design. Threaded fasteners, such as screws or bolts, 170 are passed into the holes 120, 130 of each pair of adjoining plates 110—passing through the through holes 130 of one of the reflective plates or mirrors 110 and into the first holes 120 of the other reflective plate or mirror 110.

In one embodiment using the reflective plate 110 as shown in FIG. 4, an adhesive such as epoxy is applied to one or both (preferable only one) of the adjacent surfaces of each pair of adjoining reflective plates 110.

For retroreflector 100 to perform well, each reflective plate or mirror 110 must be aligned so that it is perpendicular (at 90 degrees) to each adjacent reflective plate or mirror 110. Properly aligned, light will enter retroreflector 100 and make three reflections off each mirror or reflective plate 110, exiting retroreflector 100 with the exiting beam being perpendicular to the entering beam.

Two embodiments of methods of assembly and alignment of retroreflector 100 will now be described. The particular embodiment that is selected may depend on the application for retroreflector 100.

A first method for assembly and alignment of the ETR is to perform a special machining operation to long side 116 of each reflective plate or mirror 110 whereby the surface of each long side 116 is machined precisely perpendicular (preferably to within a few seconds of arc) to reflective mirror surface 112. This will insure that when long side 116 of each reflective plate or mirror 110 is attached to short side 118 of the adjoining reflective plate or mirror 110, the resulting angle between any two neighboring mirrors will be 90 degrees.

The second method for assembly and alignment incorporates a very thin layer of epoxy filler between long side 116 of each reflective plate or mirror 110 and the portion of the reflective surface 112 of the adjoining reflective plate or mirror which long side 116 abuts. One preferred adhesive is J-B WELDS (manufactured by J-B WELDS Co., Sulphur Springs, Tex.), but other adhesives can be used. Beneficially, the adhesive is not used to hold the ETR together, but rather it is used as a filler. Beneficially, the adhesive is placed on reflective surface 112 in a series of stripes between through-holes 130. Care is taken so that when reflective plates or mirrors 110 are put together and the glue is pressed out, excess material does not seep into any screw threads in through-holes 130. Once the adhesive is applied, retroreflector 100 is assembled and then aligned and held in proper alignment until the epoxy fully cures. The adhesive, which is captured between two surfaces, thereby forms a “compensation surface” and compensates for any angular error that exists between the long side and reflective surface of each mirror panel. Once cured, retroreflector 100 threaded fasteners, such as screws or bolts, 170 are passed through aligned pairs of first holes 120 and through-holes 130, and alignment is verified.

Turning again to FIGS. 1 and 2, in one embodiment, ETR 100 may mounted by affixing a single, rigid-arm mount 180 to retroreflector 100, using existing holes 120, 130 provided in reflective plates or mirrors 110 of retroreflector 100 and a hole 185 in mount 180. In this case, longer threaded fasteners, such as screws or bolts, 170 are employed to couple mount 180 and two adjoining reflective plates or mirrors 110 of retroreflector 100. This construction is shown in FIG. 2. Although not shown in FIGS. 1 and 2, alternatively, a first set of threaded fasteners 170 may attach a first one of the reflective plates or mirrors 110 to mount 180 by means of one or more of the holes 120, 130, and a second set of threaded fasteners 170 may attach the first reflective plate or mirror 110 to an adjoining reflective plate or mirror 110 by means of one or more separate holes 120, 130. In that case, longer threaded fasteners 170 may not be required.

Beneficially, mount 180 is constructed of the same material as reflective plates or mirrors 110 of retroreflector 100. Beneficially, this allows for excellent thermal stability since there is not any mismatch of materials, and therefore mount 180 and retroreflector 100 will have the same thermal coefficient of expansion.

Beneficially, ETR 100 and ETR assembly 200 as described above exhibit substantially improved tolerance of extreme high and low temperatures and will tolerate extreme temperatures well above and below that of other hollow retroreflectors that are assembled by gluing three mirrors together, without suffering loss of optical performance or suffering catastrophic failure. One embodiment of ETR 100 described above has been tested up to 500 degrees F. without loss of optical performance or catastrophic failure.

Another benefit of ETR 100 as described above is that it is virtually indestructible compared to the hollow retroreflectors which are assembled by gluing three mirrors together. Beneficially, ETR 100 is made of metal (preferably aluminum, but other metals can be used such as steel, beryllium, etc.) which are held together by screws. Metal, being very strong and capable of withstanding very strong forces therefore makes a superior material for the construction of retroreflectors, if properly assembled.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

We claim:

1. A hollow retroreflector, comprising:
three mutually perpendicular reflective plates each having at least one hole in a surface thereof; and
at least three threaded fasteners, each one of the threaded fasteners passing though the holes of an adjoining pair of the three mutually perpendicular reflective plates.

2. The hollow retroreflector of claim 1, further comprising epoxy disposed between adjacent surfaces of each of the adjoining pairs of reflective plates.

3. A hollow retroreflector assembly, comprising:
a hollow retroreflector, including
three mutually perpendicular reflective plates each having at least one hole in a surface thereof, and
at least three threaded fasteners, each one of the threaded fasteners passing though the holes of an adjoining pair of the three mutually perpendicular reflective plates; and
a hollow retroreflector mount having a hole passing therethrough,
wherein at least one of the screws or bolts passes through the hole in the mount and through the at least one hole of one of the reflective plates.

4. The hollow retroreflector assembly of claim 3, further comprising epoxy disposed between adjacent surfaces of each pair of adjoining reflective plates.

5. A method of making a hollow retroreflector comprising;
arranging three reflective plates, each having at least one hole in a surface thereof, to be mutually perpendicular to each other to form three adjoining pairs of reflective plates; and
passing a threaded fastener though the holes of each adjoining pair of reflective plates.

6. The method of claim 5, further comprising applying epoxy to at least one surface of each adjoining pair of reflective plates before passing the threaded fastener through the holes of the adjoining pair of reflective plates.

7. A method of making a hollow retroreflector assembly, comprising:
arranging three reflective plates, each having at least one hole in a surface thereof, to be mutually perpendicular to each other to form three adjoining pairs of reflective plates; and
passing a threaded fastener though the holes of each adjoining pair of reflective plates,
wherein at least one of the threaded fasteners is also passed through a hole in a hollow retroreflector mount.

8. The method of claim 7, further comprising applying epoxy to at least one surface of each pair of adjoining reflective plates before passing the screw or both through the holes of each pair of adjoining reflective plates.

9. A method of making a hollow retroreflector assembly, comprising:
arranging three reflective plates, each having one or more holes in a surface thereof, to be mutually perpendicular to each other to form three adjoining pairs of reflective plates;
passing a first threaded fastener though at least one of the holes of each adjoining pair of reflective plates; and
passing a second threaded fastener through at least a second one of the holes in one of reflective plates and through a hole in a hollow retroreflector mount.

10. The method of claim 9, further comprising applying epoxy to at least one surface of each pair of adjoining reflective plates before passing the screw or both through the holes of each pair of adjoining reflective plates.
